(19) United States
(12) Patent Application Publication
(10) Pub. No.: US 2017/0242676 A1
(43) Pub. Date: Aug. 24, 2017

(54) CONTROL SYSTEM ENABLING COMPARISON BETWEEN TWO CHARACTER STRINGS AND METHOD OF INSTALLING A NEW CONFIGURATION IN AN AIRCRAFT

(71) Applicant: AIRBUS OPERATIONS (S.A.S.), Toulouse (FR)

(72) Inventor: Anne FRAYSSIGNES, Saint-Andre (FR)

(21) Appl. No.: 15/436,386

(22) Filed: Feb. 17, 2017

(30) Foreign Application Priority Data
Feb. 18, 2016 (FR) 1651349

(51) Int. Cl. G06F 9/445; B64F 5/40; G06K 9/46; G06F 17/22; G06K 9/34

(52) U.S. Cl. CPC G06F 8/61; G06F 17/2211; G06K 9/344; G06K 9/4652; B64F 5/40; G06K 2209/01

(57) ABSTRACT

A control system and method enabling comparison of first and second character strings, the control system comprising a first source of information supplying the first string and a second source of information embedded in an aircraft and supplying the second string. A first processing module can model the first character string, each first character string character divided into a given number H×W of standardized elements comprising sign elements and background elements. The first processing module can transform each character into a standardized image. A second processing module can model the second character string, each character divided into H×W standardized elements comprising sign elements and background elements, and can transform each character into a standardized image in which each standardized element is associated with a comparison code. A comparison module can load the first string into the first module and load the second string into the second module for processing.

### CROSS-REFERENCE TO RELATED APPLICATION

This application claims priority to French Patent Application FR 16 51349, filed Feb. 18, 2016, the entire disclosure of which is incorporated by reference herein.

### TECHNICAL FIELD

The present disclosure relates to the general field of aeronautics, more particularly embedded systems, such as the avionic systems (electronic, electrical and computer systems which assist in the piloting), embedded on an airplane either totally, or partly, the non-embedded part still however being within the aeronautical field but forming part of the ground support equipment or of the tools dedicated to airplane maintenance support.

### BACKGROUND

The disclosure herein relates more particularly to the updating of embedded avionics equipment. To equip an aircraft according to a new configuration, a maintenance operator uses a control terminal embedded in the aircraft in which the operator inserts an information medium containing new software versions driving the various embedded avionics equipment items of the aircraft. The update is performed on each equipment item in turn or on each group of equipment items in turn and the operator must indicate, for each equipment item or group of equipment items, if an update is necessary or not for the new configuration.

To this end, all the equipment items are referenced using at least two identifiers (“part number” or “functional item number”), one relating to the hardware part of the equipment item that will be called “hardware equipment identifier”, the other relating to the software part of the equipment item, herein below referred to as “software equipment identifier”. An “identifier of an object” should be understood to be a character string making it possible to identify the object. The software and hardware identifiers of an equipment item are stored in the equipment item and can be retrieved in the embedded control terminal either upon request input into the embedded control terminal or because the equipment item transmits these identifiers regularly to the terminal.

Similarly, any new software version that has to be installed in an equipment item is also referred to by at least two identifiers: one relating to the hardware part of the corresponding equipment item, here referred to by the terms “update hardware identifier”, the other relating to its software part, designated “update software identifier”.

When a maintenance operator has to perform the installation of a new configuration in an aircraft, the operator has two tools available:

on the one hand, a paper or electronic job card. When it is electronic, the job card can be stored in a mobile tool like a tablet, a portable computer or a PDA (Personal Digital Assistant) or stored in a ground terminal, which job card contains all the software and hardware identifiers of the updates to be performed;

on the other hand, for each equipment item or group of equipment items on which the operator actually intervenes, the equipment software and hardware identifiers, supplied by the embedded control terminal and displayed on a screen of the embedded control terminal or on another display device of the human-machine interface of the aircraft.

For a new configuration to be correctly installed in the aircraft, the operator must check the match between the identifiers supplied by his or her job card (which job card indicates the equipment items to be updated) and the identifiers supplied by the human-machine interface of the aircraft (which correspond to the equipment items on which an operation is, has been or will be performed, that is to say the equipment items actually ultimately updated).

Hitherto, this check was performed by the maintenance operator by visual, global or character-by-character comparison of the identifiers (software+hardware) of the update and of the identifiers (software+hardware) of the equipment item, and this was done for each equipment item or group of equipment items to be updated.

These comparisons are the sources of numerous errors. Comparing two character strings may seem simple but in reality it is a difficult operation: a human brain can easily reverse two characters without noticing. Furthermore, a fatigue effect can occur. Such a comparison is even more difficult for an operator whose mother tongue does not use the alphabet used for the character strings the operator is faced with, in this case the Latin alphabet, or for an operator who is not used to writing or reading instructions in English on a daily basis.

### SUMMARY

The disclosure herein aims to mitigate these drawbacks by disclosing a control device and method that makes it possible to simplify the comparison of two character strings without having to read them.

To this end, the disclosure herein proposes two main alternative versions, but versions which are not exclusive, the second version of the disclosure herein being able to be used for example to confirm the first.

Hereinbelow, a “character” should be understood to be, for the human eye, a cell comprising a background on which a sign (and just one sign) such as a letter or a digit is plotted. The height and the width of a character is given by the height and the width of the cell, the height of the signs preferably corresponding to the height of the cells. Moreover, each character is divided into elements, which are therefore respectively either sign elements or background elements depending on whether they are situated on the sign or the background of the character.

In its two versions, the disclosure herein proposes a control system enabling a comparison of a first character string and of a second character string, the system comprising a first source of information supplying the first character string and a second source of information embedded in an aircraft and supplying the second character string.

In both versions of the disclosure herein, the control system comprises: a first processing module configured to model the first character string on a pre-established formal scheme, each character of the first character string then being transformed into a “standardized image” divided into a given number H×W of standardized elements (of uniform size, that is to say identical from one element to another) comprising sign elements and background elements, the first processing module being also configured to enrich each standardized image as an “enriched standardized image” in which each standardized (sign or background) element is associated with a comparison code which is either a display color, or a bit value, all the sign elements being associated with a same first comparison code, all the background elements being associated with a same second comparison code which is opposite to the first comparison code, a second processing module configured, in a manner similar to the first processing module, to transform each character of the second character string into an enriched standardized image, which is standardized according to the same pre-established formal scheme, each character of the second character string being divided into H×W standardized elements comprising sign elements and background elements, and which is enriched in that each standardized (sign or background) element of the image is associated with a comparison code which is either a display color, or a bit value, all the sign elements of the second character string being associated with a same third comparison code, all the background elements of the second character string being associated with a same fourth comparison code which is opposite to the third comparison code.

In other words, the processing of each character string consists of or comprises first of all “redrawing” the characters of the string in accordance with a graphic scheme, then in transforming each duly redrawn character into a “pixelated” image of which each element is then associated either with a display color (first version of the disclosure herein) or with a bit value (second version of the disclosure herein, the enriched standardized image of the character is then a binary matrix image).

The control system according to the disclosure herein (in both its versions) also comprises:

a comparison module configured to, in response to an action to start a comparison operation by an operator,
load the first character string into the first processing module and load the second character string into the second processing module for them to be processed,
for each pair of characters to be compared formed by a first character belonging to the first character string and a second character belonging to the second character string, perform a superposition of the enriched standardized images of the characters, element by element, each element of the enriched standardized image of the first character being superposed on a corresponding element of the enriched standardized image of the second character, the superposition of two elements giving rise to an operation on their comparison code.

Note that the pre-established formal scheme defined above comprises for example, in particular, the font and the size of character and sign to be used to process each character string.

Moreover, the first source of information can be: a job card stored in a portable maintenance tool, a job card stored in a ground maintenance terminal; a paper job card on which the first character string is represented in the form of a bar code or any other code that can be scanned for the purposes of transforming and storing the corresponding character string as a series of bits.

It should be noted that the first processing module and the second processing module can be incorporated in the same hardware and form just one module, or, on the contrary, be incorporated in different hardware. For example, the first processing module may be incorporated in a portable or ground maintenance tool and the second processing module may be incorporated in an embedded control terminal in the aircraft.

In the first version of the disclosure herein, the control system also has the following features:

it comprises a display screen, called multilayer screen, comprising at least one first logic layer and one second logic layer,
the comparison codes are display colors, two different colors being considered as opposite comparison codes,
the first and second processing modules are configured to construct reversed enriched standardized images, that is to say that
the first comparison code and the third comparison codes are opposite; in other words, the first comparison code and the third comparison code are different colors (Example 1, white and red; Example 2, white and transparent),
the first comparison code and the fourth comparison code are the same (in Examples 1 and 2, white),
that the second comparison code and the third comparison code are the same (Example 1: red; Example 2: transparent),
in other words, a same first color A (for example, white) is assigned to the sign elements of the first character and to the background elements of the second character, and a same second color B (Example 1: transparent, Example 2: red), different from the first color A, is assigned to the background elements of the first character and to the sign elements of the second character. In other words, the first processing module is configured to construct enriched standardized images having signs of color A on a background of color B (Example: white signs on a transparent background, or Example 2: white signs on a red background) while the second processing module is configured to construct enriched standardized images having signs of color B on a background of color A (in the example, transparent or red signs on a white background);
   the superposition operation consists of or comprises displaying a resultant image from a reference point in a check zone of the multilayer screen, the resultant image corresponding to the superposition of the first and second character strings processed, each element of the resultant image being displayed using a pixel whose color is a mix of the colors (for example the sum of the RGB percentages) of the corresponding superposed elements. Thus, an element of the resultant image which results from the superposition of an element of color A and of an element of color B is displayed using a pixel of a color A+B, an element of the resultant image which results from the superposition of two elements of color A is displayed using a pixel of color A, an element of the resultant image which results from the superposition of two elements of color B is displayed using a pixel of color B.

To return to the preceding examples, in the superposition operation:
an element of the resultant image which results from the superposition of a white element of the enriched standardized image of the first character and of a white element of the enriched standardized image of the second character is displayed using a white pixel (in other words, white+white gives white),
moreover, in the Example 1, an element of the resultant image which results from the superposition of a transparent element of the enriched standardized image of the first character and of a transparent element of the enriched standardized image of the second character (transparent+transparent) is displayed using a pixel that is off (that is to say a pixel for which all the RGB percentages are zero, such a pixel therefore appearing black), and finally white+transparent (like transparent+white) gives white,
in the Example 2, red+red gives red, and finally white+red (like red+white) gives pink.

Throughout the following, the expression “first character” designates a character of the first character string and the expression “second character” designates a character of the second character string, the expression “corresponding second character” indicating that is the character of the second character string that has the same rank as a first character considered, that is to say that it is the character of the second character string that is to be compared to the first character considered.

Thus, in the first version of the disclosure herein, when two character strings to be compared are displayed, with a superposition and after a processing according to the disclosure herein, and if the character strings are identical, each element of the color A (sign element) of a first character will be superposed on an element of color B (sign element) of the corresponding second character and each element of color B (background element) of the first character will be superposed on an element of color A (background element) of the corresponding second character, and this will be done for each pair of characters to be compared, that is to say for each character of the first (or of the second) character string. All the elements of the resultant image are then associated with a pixel of color A+B. The image resulting from the superposition of two identical character strings therefore appears as uniformly colored.

Consequently, if the two character strings are identical, by superposing them after processing as previously explained, the check zone appears to uniformly have a color A+B.

Conversely, if the check zone is not thus uniformly colored, for example if it comprises at least one pixel of another color because of the superposition of two elements of same color A or of same color B (i.e., in the preceding examples, a white, black or red pixel), it is possible to deduce therefrom that there are, in the character strings, at least two characters of the same rank which are not identical.

In addition, if two characters to be compared are different, there is necessarily at least one pixel which is not of the color A+B. It can be deduced therefrom that, if the check zone is uniformly colored, the two character strings are identical.

Thus, the first version of the disclosure herein offers a simple way of visually checking two information items are identical. The operator is no longer obliged to read the information items and check that they match, character by character. It is sufficient for him or her to look to see if the check zone is of uniform color.

According to a possible feature of this first version of the disclosure herein, the control system comprises a portable electronic maintenance tool and the multilayer display screen is incorporated in this tool.

As a variant, the multilayer display screen is embedded in the aircraft. In this variant, the control system comprises, for example, an embedded control terminal in the aircraft and the multilayer display screen is incorporated in this embedded control terminal. It is also possible to envisage using a multilayer screen incorporated in an equipment item of the aircraft, without departing from the disclosure herein.

The first processing module can be incorporated in the abovementioned portable electronic maintenance tool and/or in the embedded control terminal.

The second processing module can be incorporated in the portable maintenance tool or in the embedded control terminal or in each embedded equipment item (each equipment item then processing the second character string which is associated with it, that is to say the identifier which defines the equipment item concerned).

The comparison module can be incorporated in the portable maintenance tool or in the embedded control terminal.

The action to start a comparison operation performed by the operator can be, for example: the input in the control terminal of the aircraft or in the portable maintenance tool of a response to a request in starting a comparison operation; the selection of an update to be performed (that is to say of a first character string) on an electronic job card; the scanning of a code and therefore of an update to be performed on a paper job card; the selection of an equipment item or groups of equipment items (that is to say of a second character string) in an embedded control terminal, etc.

The above four paragraphs apply also to the second version of the disclosure herein.

It should be noted that the embedded control terminal also comprises a loading module and information medium reader for loading the updates stored on a portable information medium supplied to the operator. This portable information medium can be incorporated in a portable maintenance tool as mentioned above.

According to an optional feature of the first version of the disclosure herein, the control system also comprises a test module

which, when it is activated by the operator, triggers the display on all of the multilayer display screen of an entirely white page in order to detect any dead or damaged pixels which will then appear black on the white page, and
which enables the operator, if the operator detects a black pixel in the check zone, to change the reference point so as to move the check zone into a zone of the screen without any dead or damaged pixel. A new reference point and a new check zone are thus defined, which will be used in all the future comparison operations.

In the second version of the disclosure herein, the control system also offers the following features:

the comparison codes are bit values, such that the enriched standardized images of the characters are binary matrix images, the value 0 and the value 1 constituting opposite comparison codes,
the superposition operation consists of or comprises, for each pair of characters to be compared (formed by a first character belonging to the first character string and a second character belonging to the second character string), constructing a check matrix whose matrix elements are the resultant of a logical operation performed term-by-term on the matrix image of the first character and on the matrix image of the second character.

Preferably, the logical operation is chosen from a logical OR operation and a logical AND operation, the logical OR operation being defined by the rules: 0 OR 0=0, 0 OR 1=1, 1 OR 0=1, 1 OR 1=0, the logical AND operation being defined by the rules: 0 AND 0=1, 0 AND 1=0, 1 AND 0=0, 1 AND 1=1.

As will be understood more easily on reading the various cases detailed hereinbelow, when two characters to be compared are identical, their check matrix is uniform (whether 1s or 0s, depending on the manner in which the binary matrix images of the characters to be compared are constructed and depending on the logical operation used to construct the check matrix) and vice versa. Consequently, it would be possible for provision to be made at this stage to display the various check matrices generated for the two character strings to be compared and to leave the operator to take care of checking the uniformity or non-uniformity of the check matrices.

However, in order to further limit the risks of error, the comparison module is preferably configured to perform the following additional steps:
for each pair of characters to be compared (and therefore for each character of the first character string), performing an intermediate sum of the elements of the check matrix,
performing a final sum of all the intermediate sums, displaying this final sum together with a reference value to which this final sum must be compared by an operator, the reference value as displayed being possibly separated from the final sum displayed by the text “to be compared to”.

In this preferred embodiment, the second version of the disclosure herein therefore transforms the comparison of two character strings into a comparison of a number with a reference value; it enables an operator to thus compare two character strings without even being aware of the content and the meaning of each of the character strings and to reduce the comparison of a plurality of characters to a comparison of a very small number of digits, even to a comparison between only two digits (when the final sum has to be compared to the zero digit).

Four embodiments are envisaged for the second version of the disclosure herein.

In the first embodiment of the second version of the disclosure herein:

the binary matrix images of the characters of the first character string and of the characters of the second character string are constructed in an inverted manner, that is to say that a bit value (for example 1) is assigned to the sign elements of the characters of the first character string and to the background elements of the characters of the second character string, the opposite value (in the example, 0) being assigned to the sign elements of the characters of the second character string and to the background elements of the characters of the first character string. In other words, a bit value (for example 0) is used to construct the signs of the first character string and the opposite value (here, 1) to construct those of the second character string. In other words, the first comparison code and the third comparison code defined initially are opposite (similarly, the second comparison code and the fourth comparison code are opposites);
the logical operation used is the OR operation and the reference value is the product Nb×H×W, in which Nb designates the number of characters of the first and second strings to be compared. If two characters to be compared are identical, the matrix images of the two characters are perfectly “reversed”, the check matrix should contain only elements of value 1 and the intermediate sum (of the check matrix) should be equal to the product H×W. Consequently, if one of the elements of the check matrix is 0, that is to say if the intermediate sum is lower than the product H×W, that means that the two characters are not identical. By extension, if two character strings to be compared are identical, all the intermediate sums are equal to the product H×W and the final sum is equal to the product Nb×H×W. Otherwise, the final sum is lower than the product Nb×H×W.

In a second embodiment of the second version of the disclosure herein,

the binary matrix images of the characters of the first character string and of the characters of the second character string are constructed in an inverted manner as previously explained for the first embodiment of the second version of the disclosure herein,
the logical operation used is the AND operation and the reference value is 0 (zero). If two characters to be compared are identical, the matrix images of the two characters are perfectly “reversed”, the check matrix should therefore contain only elements of value 0 and the intermediate sum of the check matrix should also be zero. Consequently, if at least one of the elements of the check matrix is 1 or if the intermediate sum is not zero, that means that the two characters are not identical. By extension, if the two character strings to be compared are identical, all the check matrices and the intermediate sums are zero. The result thereof is that the final sum is also zero. Conversely, if the final sum is not zero, it is possible to deduce therefrom that the character strings are not identical.

In a third embodiment of the second version of the disclosure herein,

the binary matrix images of the characters of the first character string and of the characters of the second character string are constructed identically, which means that a bit value (for example 1) is assigned to the sign elements of the characters both of the first character string and of the second character string, the opposite bit value (in the example, 0) being assigned to the background elements of the characters of the first and second character strings; in other words, the first and third comparison codes initially defined are equal (similarly, the second and fourth comparison codes are equal);
the logical operation used is the OR operation and the reference value is 0 (zero). If two characters to be compared are identical, the matrix images of the two characters are perfectly identical, the check matrix should contain only elements of value 0. By extension, if two character strings to be compared are identical, all the check matrices and the intermediate sums are zero, the result thereof is that the final sum is also zero. Therefore, if the final sum is not zero, it can be deduced therefrom that the character strings are not identical. Conversely, if two characters to be compared are not identical, there is necessarily at least one sign element of one of the characters which will correspond to a background element of the other character and therefore the check matrix of these two characters necessarily comprises at least one element of value 1. Therefore, if the final sum is zero, that is to say if all the intermediate sums (and all the check matrices) are zero, it is possible to deduce therefrom that the two character strings are identical.

In a fourth embodiment of the second version of the disclosure herein, the binary matrix images of the characters of the first character string and of the characters of the second character string are constructed identically as explained for the third embodiment,

the logical operation used is the AND operation and the reference value is the product Nb×H×W, in which Nb denotes the number of characters of the first and second strings to be compared. If two characters to be compared are identical, the matrix images of the two characters are perfectly “identical”, the check matrix must then contain only elements of value 1 and the intermediate sum (of the check matrix) must be equal to the product H×W. Consequently, if one of the elements of the check matrix is 0, that is to say if the intermediate sum is lower than the product H×W, that means that the two characters are not identical. By extension, if two character strings to be compared are identical, all the intermediate sums are equal to the product H×W and the final sum is equal to the product Nb×H×W. Otherwise, the final sum is lower than the product Nb×H×W.

Advantageously and according to the disclosure herein, in its two versions, the control system also comprises a validation module making it possible, upon input by the operator of a response to a validation request aiming to confirm or deny that the two character strings are identical, to terminate a comparison operation. Thus, the operator retains responsibility for the comparison and the validation thereof, which makes it possible to use DAL A apparatuses (DAL being the acronym for “Design Assurance Level”) conforming to current standards and in particular to the ARINC 661 standard.

The validation module can be incorporated in the portable maintenance tool and/or in the abovementioned embedded control terminal.

The disclosure herein extends to a computer program enabling two character strings to be compared, characterized in that it comprises a first processing module, a second processing module and a comparison module as defined above.

The disclosure herein also proposes a method for installing a new configuration in an aircraft, in which a job card listing updates to be performed is supplied to an operator, and in which, for each of the updates listed in the job card:

the operator selects an embedded equipment item in the aircraft or a group of embedded equipment items via an embedded control terminal,
a comparison operation is performed between a first character string supplied by the job card and identifying the update, and a second character string supplied by the equipment item or group of equipment items selected and identifying the equipment item or group of equipment items selected,
the operator triggers the installation of the update of a piece of software in the equipment item or group of equipment items selected by validating the comparison when the first and second character strings are identical.

The method according to the disclosure herein is characterized in that the operator uses a control system according to the disclosure herein to perform each of the comparison operations.

When the operator uses a control system according to the first version of the disclosure herein, to terminate a comparison operation via the validation module, the operator validates the comparison when the check zone of the display screen uniformly displays just one and the same color (in this case the color A+B defined above), the operator does not validate the comparison when at least one pixel of the check zone does not display the same color as the other pixels of the check zone.

When the operator uses a control system according to the second version of the disclosure herein, to terminate a comparison operation via the validation module, the operator validates the comparison when the final sum is equal to the reference value, the operator does not validate the comparison when the final sum is not equal to the reference value.

More precisely, when the operator uses a control system according to the first embodiment of the second version of the disclosure herein, to terminate a comparison operation via the validation module, the operator validates the comparison when the final sum is equal to Nb×H×W, the operator does not validate the comparison when the final sum is lower than Nb×H×W.

When the operator uses a control system according to the second embodiment of the second version of the disclosure herein, to terminate a comparison operation via the validation module, the operator validates the comparison when the final sum is zero, the operator does not validate the comparison when the final sum is non-zero.

When the operator uses a control system according to the third embodiment of the second version of the disclosure herein, to terminate a comparison operation via the validation module, the operator validates the comparison when the final sum is zero, the operator does not validate the comparison when the final sum is non-zero.

When the operator uses a control system according to the fourth embodiment of the second version of the disclosure herein, to terminate a comparison operation via the validation module, the operator validates the comparison when the final sum is equal to Nb×H×W, the operator does not validate the comparison when the final sum is lower than Nb×H×W.

The disclosure herein extends to a control system and a method for installing a new configuration in an aircraft that are characterized in combination by all or some of the features mentioned above and below.

### BRIEF DESCRIPTION OF THE DRAWINGS

Other details and advantages of the present disclosure will become apparent on reading the following description, which refers to the attached schematic drawings and relates to preferential embodiments, provided as nonlimiting examples. In these drawings:

FIG. 1 represents a table providing an example of an identifier used in aeronautics.

FIG. 2 is a detailed representation of a few characters of the character string of FIG. 1 after processing according to the disclosure herein.

FIG. 3 is a schematic representation of the various components of a control system according to the disclosure herein.

FIG. 4 is an exploded symbolic representation of a multilayer screen that can be used in the first version of the disclosure herein.

FIG. 5 illustrates, in the form of application windows, stages of a method according to the disclosure herein for installing a new configuration in an aircraft.

FIG. 6A illustrates the result of a comparison of two identical identifiers, such that this result is displayed on the multilayer screen of FIG. 4 in the context of a method according to the disclosure herein.

FIG. 6B illustrates the result of a comparison of two different identifiers, such that this result is displayed on the multilayer screen of FIG. 4 in the context of a method according to the disclosure herein.

FIG. 7A illustrates the binary matrix images of two identical characters and their check matrix according to the second embodiment of the second version of the disclosure herein.

FIG. 7B illustrates the binary matrix images of two different characters and their check matrix according to the second embodiment of the second version of the disclosure herein.

### DETAILED DESCRIPTION

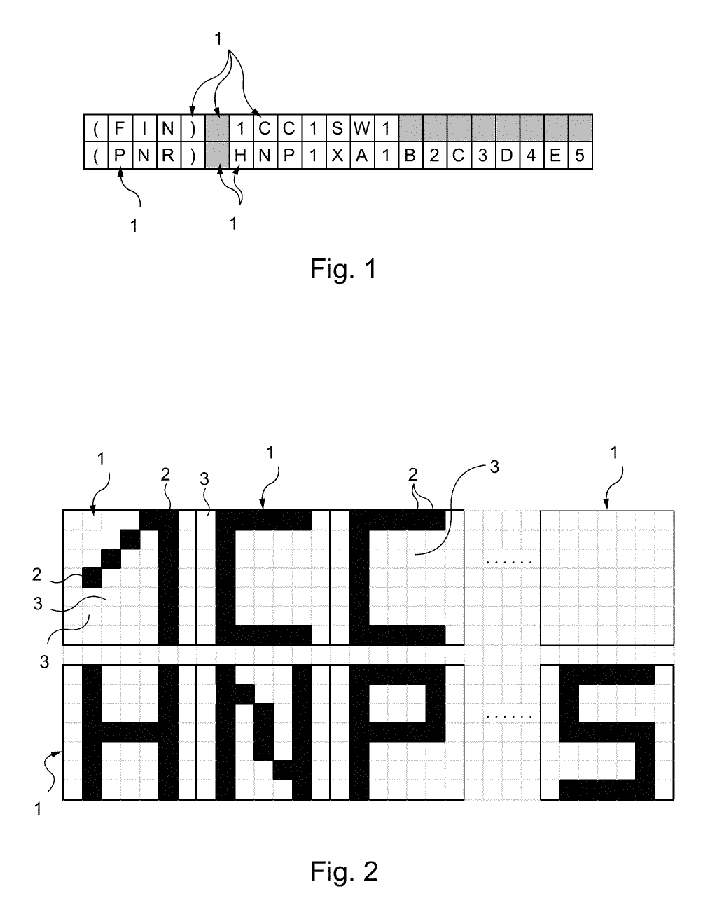

The table illustrated in FIG. 1 is an example of hardware or software identifier used in aeronautics. The identifier concerned has a first line corresponding to a functional item number FIN and a second line corresponding to a model number, or “part number” PNR, these two numbers together making it possible to identify with certainty a software or hardware part of an aeronautical equipment item. This identifier comprises 2×21 characters. Each character 1 is a cell or box comprising a sign, that is to say a digit or a letter, and a background on which the sign is added; each character 1, “drawn” according to a pre-established formal scheme, can be divided into sign elements 2 and background elements 3 as illustrated in FIG. 2.

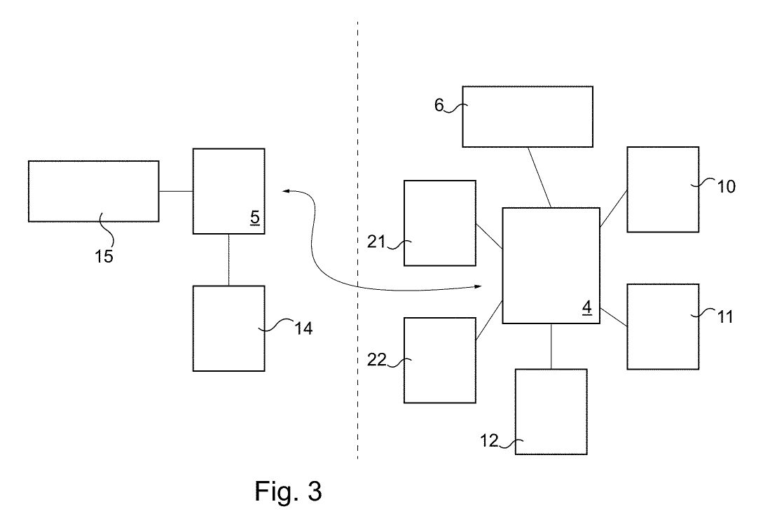

In the context of a method for installing a new configuration in an aircraft, a maintenance operator must install updates of software used by various embedded equipment items in the aircraft. These updates are stored on a software medium handed over to the operator with a job card indicating the equipment items concerned in the form of a list of identifiers (FIN+PNR) representing the updates. In the example described below and which uses a control system as illustrated in FIG. 3, the job card is an electronic job card 14 stored in a portable maintenance tool 5 (of tablet type) that the operator can connect to an embedded control terminal 4 of the aircraft to exchange data (by wired or wireless means), and the software medium in which the updates are stored is a memory 15 of the maintenance tool 5.

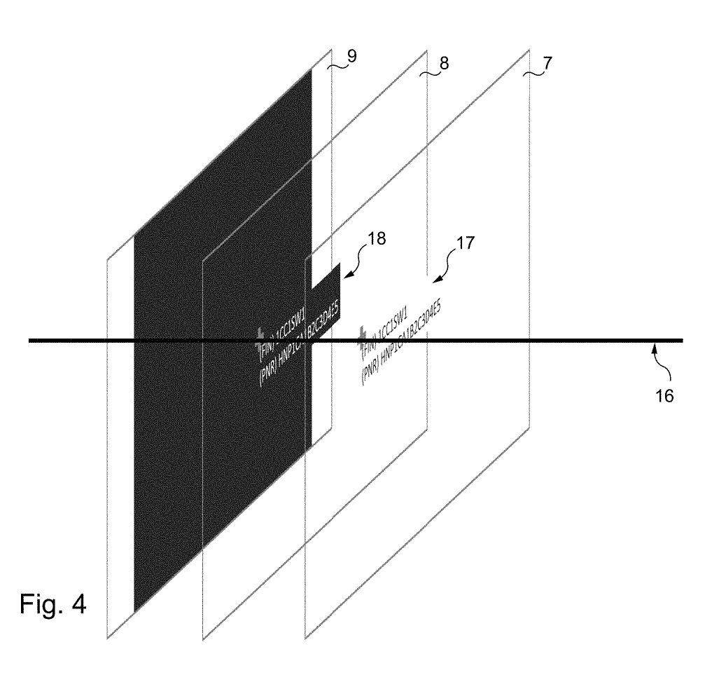

Moreover, the embedded control terminal 4 comprises a screen 6. The screen 6 is qualified as multilayer because it comprises at least one first logic layer 7, one second logic layer 8 and possibly a background layer 9 (see FIG. 4). In such a screen, everything happens as if the image displayed on the screen were the result of the superposition of images, “virtually displayed” on each of the logic layers 7-9, although such a screen preferentially comprises only one, and just one, thickness of physical pixels. In other words, if it is considered that each logic layer is divided into cells each corresponding to a pixel of the screen, each pixel of the screen has a corresponding cell of the first logic layer 7, a cell of the second logic layer 8 and, if necessary, a cell of the background 9. The “virtual display” of an image on a logic layer 7-9 amounts to associating with each cell of the logic layer display information defined by the image. The colors and the intensity of each pixel of the screen are then determined by the combination of display information (usually, and logically, it is the sum of the RGB percentages) associated with the cells of the various layers corresponding to the pixel concerned. An exploded representation of the screen 6 can be observed in FIG. 4. It is a symbolic representation, the logic layers 7-9 not having any physical reality.

When an update is downloaded into the embedded control terminal 4 and then is installed in an equipment item or group of equipment items, the operator must ensure that the update does indeed have the same software and hardware identifiers as the equipment item selected. To this end, according to the disclosure herein, the maintenance operator has a control system and a control application incorporated at least partly in the control terminal 4, and which comprise a first processing module 10, a second processing module 11 and a comparison module 12.

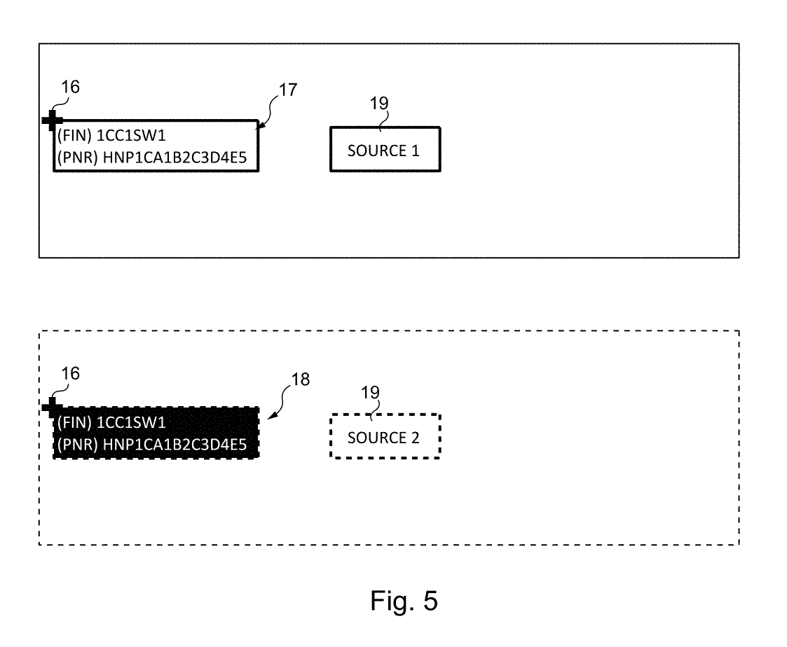

A first window of the control application presents a widget 19 called “source” (see top of FIG. 5 where only a portion of the window is represented) making it possible to select a source of information supplying a first identifier. A first press on the source widget 19 triggers the downloading into the first processing module 10, from the job card 14 stored in the portable maintenance tool 5, of a first (hardware or software) identifier of a first update previously downloaded and installed into an equipment item or currently being downloaded or installed, or to be downloaded and installed.

In the first version of the disclosure herein, the first processing module 10 then models the first identifier according to a pre-established formal scheme and defines each sign element of the first identifier as being a transparent element and each background element of the first identifier as being a white element. This processing amounts to “virtually displaying” the duly processed first identifier on the first logic layer 7 of the screen with transparent signs on white background, which means that each sign element of the characters of this first identifier will have no impact in determining the color and the intensity of the corresponding pixel in the final display (the contribution of this sign element to the RGB percentages of the corresponding pixel of the screen is zero; everything happens as if this sign element were transparent in the superposition of the images associated with the various logic layers). It should be noted that the transparent elements (the signs in this case) appear in black in FIG. 4 because the black color corresponds, in pixel terms, to pixels that are off. The first identifier processed is “virtually displayed” on the first logic layer 7 from a pre-established reference point (the reference point is represented here by a line 16 because of the exploded representation of the screen). The first identifier thus processed and “virtually displayed” has a length and a height defining a first virtual check zone 17 on the first logic layer 7. In this example, the height of the first virtual check zone 17 corresponds to two times the height of a character since the identifier comprises two lines of characters.

A second press (see bottom part of FIG. 5) on the source widget 19 triggers the downloading, into the second processing module 11, of a second identifier which is the identifier of the equipment item in which the update associated with the first identifier has been installed or is currently being installed. Like the first identifier, this second identifier is modeled by the second processing module 11 on the pre-established formal scheme; moreover, it is “virtually displayed” on the second logic layer 8 from the same reference point identified by the line 16, but with white signs on a transparent/black background. The second identifier thus displayed occupies a second virtual check zone 18 (on the second logic layer 8) which is exactly superposed on the first virtual check zone 17 of the first logic layer 7, to define on the screen 6 a check zone 20 corresponding to the pixels which will serve to display the superposition of the first and second identifiers.

A third press on the source widget 19 triggers the loading of the first and second identifiers as previously processed into the comparison module 12, which provokes the display on the screen 6 of the two identifiers superposed, that is to say the display of the image resulting from the superposition of the images “virtually displayed” on the logic layers 7 and 8 (and 9 if necessary) in a check zone 20. The resultant image therefore corresponds to the superposition of the first identifier, with transparent/black signs on a white background, and of the second identifier, with white signs on a transparent/black background. This third press on the “source” widget also provokes the display of a “validate” widget and of a “do not validate” widget, linked to a validation module 21.

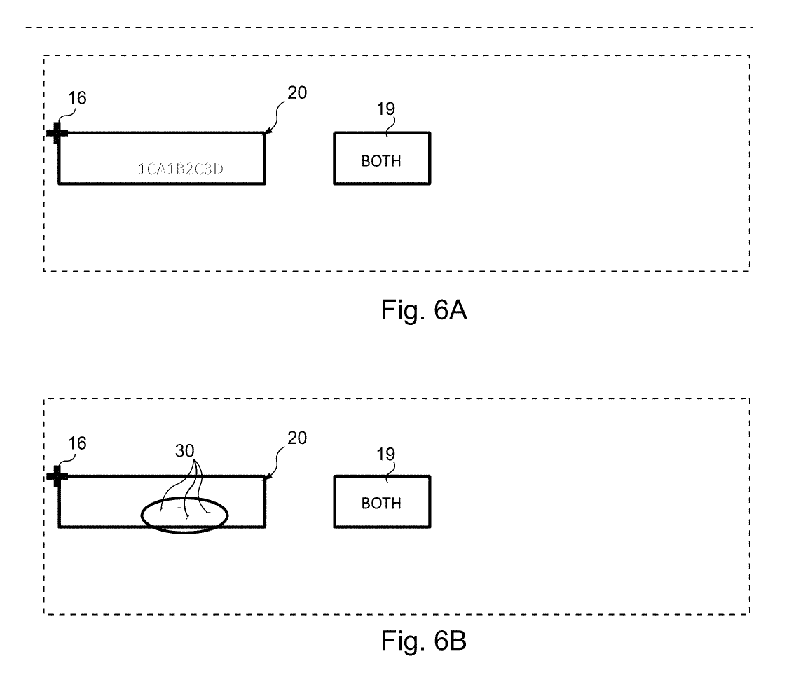

If the two identifiers are identical, the resultant image is white as illustrated in FIG. 6A. The characters of the identifiers are here represented in relief with light lines for comprehension purposes; but in reality, the check zone 20 is uniformly white. In case of difference between the identifiers, black pixels 30 appear in the check zone 20 as illustrated in FIG. 6B.

It can be deduced therefrom that:

The presence of a black pixel in the check zone 20 reflects the fact that the identifiers are different, provided that it is not a dead or damaged pixel, which can be checked using a test module 22. If necessary, the position of the black pixels in the check zone 20 enables the operator to determine the characters which differ from one identifier to the other.

In the absence of a black pixel, that is to say if the check zone 20 is entirely white (FIG. 6A), the two identifiers are identical.

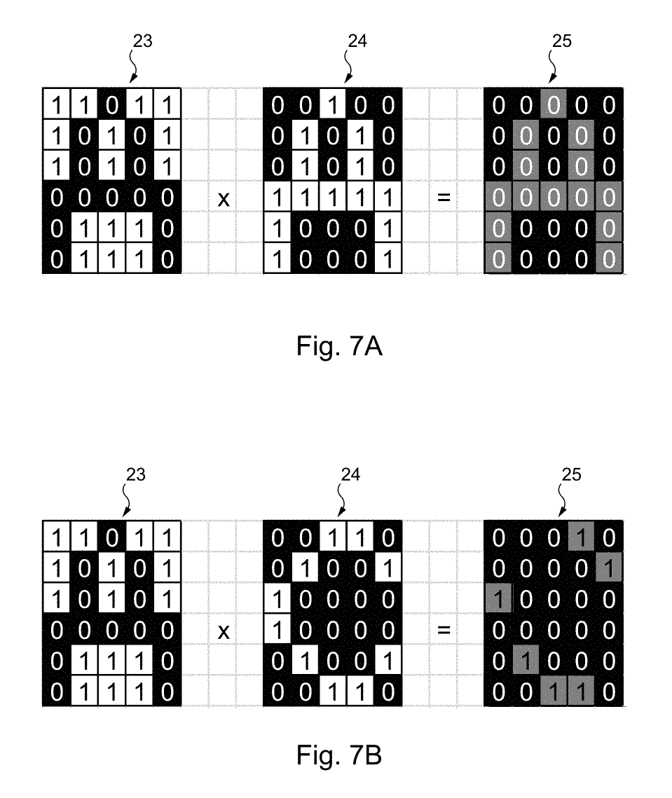

In the second version of the disclosure herein, a first press on the widget 19 also triggers the downloading of the first identifier into the first processing module 10. Here again, the first processing module 10 models the first identifier according to a pre-established formal scheme. Next, the two versions of the disclosure herein differ. In the second version, instead of assigning a display color to each standardized element 1 of the first character string, the first processing module 10 assigns a bit value to the elements. In other words, the first processing module 10 transforms each character of the first identifier into a binary matrix image 23 as illustrated in FIGS. 7A and 7B by way of example for the sign A as a capital letter. In the example illustrated, the matrix image 23 comprises 7 columns and 6 rows and the value 0 is associated with each sign element of the character whereas the value 1 is associated with each background element of the character (the opposite is of course possible). It will be observed that this example has been produced with a formal scheme which is not exactly the same as that employed for the preceding examples—FIG. 2—which provided standardized images having 7 rows and 7 columns. Obviously, if the two versions of the disclosure herein are used in succession to confirm a comparison operation, it is preferable to use the same formal scheme in the two versions in order to produce, for each character, only a single standardized image (and thus save on a processing step) to which are then assigned, on the one hand, display colors and, on the other hand, bit values.

A second press on the source widget 19 triggers the downloading of the second identifier into the second processing module 11, the modeling thereof according to the pre-established formal scheme and the transformation of each of the characters into a binary matrix image 24, of the same dimensions (7 columns and 6 rows in the example illustrated) as the binary matrix images 23 created for the first identifier.

A number of embodiments are possible, four have been described above, just one will be detailed hereinbelow by way of example (that which corresponds to the second embodiment above).

Each character of the second identifier is therefore transformed into a 6×7 binary matrix image in which the value 1 is assigned to each sign element whereas the value 0 is assigned to each background element of the character. The matrix images of the first and second identifiers are therefore constructed in reverse in this example.

A third press on the source widget 19 triggers the loading of the first and second identifiers as previously processed, into the comparison module 12, which then computes a check matrix 25 for each pair of characters to be compared, by using the AND logical operation.

When two characters to be compared are identical, each sign element of the first character, represented by the value 0, corresponds to a sign element of the second character, of value 1. Each element of the check matrix corresponding to a sign element of the first character therefore has the value 0 AND 1=0. Similarly, each background element of the first character, represented by the value 1, corresponds to a background element of the second character, of value 0, and the corresponding element of the check matrix has the value 1 AND 0=0. In conclusion, when two characters to be compared are identical, all the elements of their check matrix 25 have the value 0. This particular case can be observed in FIG. 7A.

The comparison module also computes the intermediate sum of each check matrix, which is zero if the check matrix has only elements that are of value 0, then the final sum of all the intermediate sums, which final sum is then displayed on the screen 6. As previously explained for the first version of the disclosure herein, also displayed are a “validate” widget and a “do not validate” widget, linked to the validation module 21.

If the first and second identifiers are identical, the final sum is zero. The reverse is also true: if the final sum is zero, the two identifiers are identical. The operator must in this case press on the “validate” widget to terminate the comparison and signal to the system that the update performed is valid, this information being then stored, via the validation module 12, in a memory of the control terminal 4 for example.

If the final sum is non-zero, it can be deduced therefrom that the two identifiers are not identical. This particular case can be observed in FIG. 7B. The operator must then press on the “do not validate” widget to terminate the comparison and signal to the system that the update performed is not valid. If the update has already been installed in the equipment item or group of equipment items corresponding to the second identifier, an update cancelation operation is launched by the validation module 12 and the operator is prompted to select another equipment item or group of equipment items in which to install the update.

It should be noted that the control system according to the disclosure herein can be configured to conduct two complementary comparisons for each update, one according to the first version of the disclosure herein, the other according to the second version, in order to limit even further any risk of error.

The disclosure herein can be the subject of numerous variants in relation to the embodiments described above and illustrated, provided that they remain within the context defined by the attached claims.

As an example, the second processing module 11 can be incorporated in the maintenance tool 5.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A control system enabling a comparison of a first character string and of a second character string, the control system comprising a first source of information supplying the first character string and a second source of information embedded in an aircraft and supplying the second character string, the control system comprising:
a first processing module configured to model the first character string on a pre-established formal scheme, each character of the first character string then being divided into a given number H×W of standardized elements comprising sign elements and background elements, the first processing module being also configured to transform each character of the first character string into a standardized image in which each standardized element is associated with a comparison code which is either a display color, or a bit value, all the sign elements being associated with a same first comparison code, all the background elements being associated with a same second comparison code which is opposite to the first comparison code;
a second processing module configured to model the second character string on the same pre-established formal scheme, each character of the second character string then being divided into H×W standardized elements comprising sign elements and background elements, the second processing module being also configured to transform each character of the second character string into a standardized image in which each standardized element is associated with a comparison code which is either a display color, or a bit value, all the sign elements being associated with a same third comparison code, all the background elements being associated with a same fourth comparison code which is opposite to the third comparison code;
a comparison module configured to, in response to an action to start a comparison operation by an operator:
load the first character string into the first processing module and load the second character string into the second processing module for them to be processed; and
for each pair of characters to be compared formed by a first character belonging to the first character string and a second character belonging to the second character string, perform a superposition of standardized images of the characters, element by element, each element of the standardized image of the first character being superposed on a corresponding element of the standardized image of the second character, the superposition of two elements giving rise to an operation on their comparison code.

2. The control system according to claim 1, comprising:
a display screen that is a multilayer screen comprising at least one first logic layer and one second logic layer;
wherein the comparison codes are display colors, two different colors defining opposite comparison codes;
wherein the first and second processing modules are configured to construct reversed standardized images, such that a first color A is assigned to all the sign elements of the first character and to all the background elements of the second character, and such that a second color B, different from the first color A, is assigned to all the background elements of the first character and to all the sign elements of the second character; and
the superposition operation comprises displaying a resultant image from a reference point in a check zone of the multilayer screen, the resultant image corresponding to the superposition of the first and second character strings processed, an element of the resultant image which results from the superposition of an element of color A and of an element of color B being displayed using a pixel of a third color A+B, an element of the resultant image which results from the superposition of two elements of color A being displayed using a pixel of color A, an element of the resultant image which results from the superposition of two elements of color B being displayed using a pixel of color B.

3. The control system according to claim 2, comprising a portable electronic maintenance tool and wherein the multilayer display screen is incorporated in the portable electronic maintenance tool.

4. The control system according to claim 2, comprising an embedded control terminal in the aircraft and wherein the multilayer screen is incorporated in the embedded control terminal.

5. The control system according to claim 2, comprising a test module which:
when activated by the operator, triggers the display on all of the multilayer screen of an entirely white page to detect any dead or damaged pixels which will then appear black on the white page; and
which enables the operator, if the operator detects a black pixel in the check zone, to change the reference point so as to move the check zone into a zone of the screen without any dead or damaged pixel.

6. The control system according to claim 1, wherein:
the comparison codes are bit values, such that the enriched standardized images of the characters are binary matrix images, the value 0 and the value 1 constituting opposite comparison codes;
the superposition operation comprises, for each pair of characters to be compared, constructing a check matrix in which the matrix elements are the resultant of a logical operation performed term-by-term on the binary matrix image of the first character and on the binary matrix image of the second character.

7. The control system according to claim 6, wherein the logical operation is chosen from a logical OR operation and a logical AND operation, the logical OR operation being defined by the rules: 0 OR 0=0, 0 OR 1=1, 1 OR 0=1, 1 OR 1=0, the logical AND operation being defined by the rules: 0 AND 0=1, 0 AND 1=0, 1 AND 0=0, 1 AND 1=1.

8. The control system according to claim 6, wherein the comparison module is configured to, in addition:
for each pair of characters to be compared, perform an intermediate sum of the elements of the check matrix; and
perform a final sum of all the intermediate sums, display the final sum as well as a reference value to which the final sum must be compared by an operator.

9. The control system according to claim 7, wherein:
the binary matrix images of the characters of the first character string and of the characters of the second character string are constructed in an inverted manner, such that the first and third comparison codes are opposite; and
the logical operation used is the OR operation and the reference value is the product Nb×H×W, in which Nb denotes the number of characters of the first and second strings to be compared.

10. The control system according to claim 7, wherein:
the binary matrix images of the characters of the first character string and of the characters of the second character string are constructed in an inverted manner, which means that the first and third character codes are opposite; and
the logical operation used is the AND operation and the reference value is 0 (zero).

11. The control system according to claim 7, wherein:
the binary matrix images of the characters of the first character string and of the characters of the second character string are constructed identically, which means that the first and third comparison codes are equal; and
the logical operation used is the OR operation and the reference value is 0 (zero).

12. The control system according to claim 7, wherein:
the binary matrix images of the characters of the first character string and of the characters of the second character string are constructed identically, which means that the first and third comparison codes are equal; and
the logical operation used is the AND operation and the reference value is the product Nb×H×W, in which Nb denotes the number of characters of the first and second strings to be compared.

13. The control system according to claim 1, further comprising a validation module making it possible, upon input by the operator of a response to a validation request aiming to confirm or deny that the two character strings are identical, to terminate a comparison operation.

14. The control system according to claim 1, comprising a portable maintenance tool and/or an embedded control terminal, wherein the first processing module is incorporated in the portable maintenance tool and/or in the embedded control terminal, and wherein the second processing module is incorporated in the embedded control terminal or in each equipment item of the aircraft, and in that the comparison module is incorporated in the portable maintenance tool and/or in the embedded control terminal.

15. The control system according to claim 1, wherein the action to start a comparison operation is chosen from the group consisting of: input in an embedded control terminal of the aircraft or in a portable maintenance tool, of a response to a request in starting a comparison operation; selection of the first character string on an electronic job card; the scanning of a code representing the first character string on a paper job card; and selection of an equipment item or group of equipment items represented by the second character string in an embedded control terminal.

16. A computer program comprising program code instructions stored on a computer-readable medium, enabling a comparison of a first character string and of a second character string, comprising:
a first processing module comprising computer-readable programming means for, when the program is run on a computer, modeling the first character string on a pre-established formal scheme, each character of the first character string then being divided into a given number H×W of standardized elements comprising sign elements and background elements, the first processing module also comprising computer-readable programming for, when the program is run on a computer, transforming each character of the first character string into a standardized image in which each standardized element is associated with a comparison code which is either a display color, or a bit value, all the sign elements being associated with a same first comparison code, all the background elements being associated with a same second comparison code which is opposite to the first comparison code;
a second processing module which comprises computer-readable programming for, when the program is run on a computer, modeling the second character string on the same pre-established formal scheme, each character of the second character string then being divided into H×W standardized elements comprising sign elements and background elements, the second processing module also comprising computer-readable programming for, when the program is run on a computer, transforming each character of the second character string into a standardized image in which each standardized (sign or background) element is associated with a comparison code which is either a display color, or a bit value, all the sign elements being associated with a same third comparison code, all the background elements being associated with a same fourth comparison code which is opposite to the third comparison code,
a comparison module which comprises computer-readable programming for, when the program is run on a computer, in response to an action to start a comparison operation by an operator,
load the first character string into the first processing module and load the second character string into the second processing module for them to be processed,
for each pair of characters to be compared formed by a first character belonging to the first character string and a second character belonging to the second character string, to perform a superposition of the standardized images of the characters, element by element, each element of the standardized image of the first character being superposed on a corresponding element of the standardized image of the second character, the superposition of two elements giving rise to an operation on their comparison code.

17. A method for installing a new configuration in an aircraft, in which a job card listing updates to be performed is supplied to an operator, and in which, for each of the updates listed in the job card, comprising:
an operator selecting an embedded equipment item in the aircraft or a group of embedded equipment items via an embedded control terminal;
performing a comparison operation between a first character string supplied by the job card and identifying the update, and a second character string supplied by the equipment item or group of equipment items selected and identifying the equipment item or group of equipment items selected;
the operator triggering installation of a software update in the equipment item or group of equipment items selected by validating the comparison when the first and second character strings are identical; and
the operator using a control system to perform each of the comparison operations,
the control system enabling a comparison of a first character string and of a second character string, the control system comprising a first source of information supplying the first character string and a second source of information embedded in an aircraft and supplying the second character string, the control system comprising:
a first processing module configured to model the first character string on a pre-established formal scheme, each character of the first character string then being divided into a given number H×W of standardized elements comprising sign elements and background elements, the first processing module being also configured to transform each character of the first character string into a standardized image in which each standardized element is associated with a comparison code which is either a display color, or a bit value, all the sign elements being associated with a same first comparison code, all the background elements being associated with a same second comparison code which is opposite to the first comparison code;
a second processing module configured to model the second character string on the same pre-established formal scheme, each character of the second character string then being divided into H×W standardized elements comprising sign elements and background elements, the second processing module being also configured to transform each character of the second character string into a standardized image in which each standardized element is associated with a comparison code which is either a display color, or a bit value, all the sign elements being associated with a same third comparison code, all the background elements being associated with a same fourth comparison code which is opposite to the third comparison code;
a comparison module configured to, in response to an action to start a comparison operation by an operator:
load the first character string into the first processing module and load the second character string into the second processing module for them to be processed; and
for each pair of characters to be compared formed by a first character belonging to the first character string and a second character belonging to the second character string, perform a superposition of standardized images of the characters, element by element, each element of the standardized image of the first character being superposed on a corresponding element of the standardized image of the second character, the superposition of two elements giving rise to an operation on their comparison code.

18. The method according to claim 17, wherein the operator uses a the control system and validates the comparison when the check zone of the multilayer screen uniformly displays one and the same color (A+B), and in that the operator does not validate the comparison when at least one pixel of the check zone does not display the same color as other pixels of the check zone.

19. The method according to claim 17, wherein the operator uses a comparison system wherein:
the comparison codes are bit values, such that the enriched standardized images of the characters are binary matrix images, the value 0 and the value 1 constituting opposite comparison codes;
the superposition operation comprises, for each pair of characters to be compared, constructing a check matrix in which the matrix elements are the resultant of a logical operation performed term-by-term on the binary matrix image of the first character and on the binary matrix image of the second character; and
wherein the operator validates the comparison when the final sum is equal to the reference value, and in that the operator does not validate the comparison when the final sum is not equal to the reference value.
